(19) United States
(12) Patent Application Publication
(10) Pub. No.: US 2009/0260525 A1
(43) Pub. Date: Oct. 22, 2009

(54) Cake pan

(76) Inventors: Brain Jordan, Chicago, IL (US); Kevin Wesling, Lombard, IL (US)

Correspondence Address: Kevin Wesling, 512 S. Craig Place, Lombard, IL, 60148, US

(21) Appl. No.: 12/386,423

(22) Filed: Apr. 17, 2009

Related U.S. Application Data
(60) Provisional application No. 61/124,580, filed on Apr. 17, 2008.

(51) Int. Cl. A47J 37/00

(52) U.S. Cl. 99/422

(57) ABSTRACT

A baking pan that includes a base having an interior surface including an interior center top surface and an interior peripheral bottom surface and a sidewall terminating at a top edge in a formed lip and transitioning at a bottom edge into the base. The sidewall has an interior sidewall span at the top edge. At least a portion of the base interior surface slopes upwardly from the interior peripheral bottom surface to the interior center top surface. The base interior surface does not slope downwardly from the interior peripheral bottom surface to interior center top surface. A vertical distance between the interior center top surface and the interior peripheral bottom surface does not exceed 10 percent of the interior sidewall span.

### CROSS REFERENCE TO RELATED APPLICATIONS

This application is entitled to the benefit of Provisional Patent Application Ser. No. 61/124,580 filed Apr. 17, 2008

### BACKGROUND OF THE INVENTION

This invention relates to baking pans. More specifically the invention relates to a baking pan having a unique geometrical shape to prevent a top surface of a cake from forming a dome.

A typical cake pan has a flat base and substantially vertical walls. In the one-piece variety shown in FIG. 1, the pan is stamped out of a single piece of metal. The base surface is flat. The sides are substantially vertical, only angled slightly to simplify manufacture of the pan as well as removal of the finished cake after baking. A second type of round cake pan is a spring form pan shown in FIG. 2. In this case the walls and base of the pan are separate pieces of material. The base of the spring form pan is flat. The vertical wall section is split vertically, allowing the diameter of the wall section to increase as the walls are pushed outward radially. The wall section is then clamped around the base, retaining it horizontally and vertically in features located on the inside surface of the sidewall. Once baking is complete the wall is unclamped, opened radially and then removed separately from the base. The base may then stay with the finished cake or be removed after the walls. A spring form cake pan is used to bake cakes that should not be turned upside down to remove the cake from the pan.

A large percentage of cakes expand when baked. A cake baked in a typical cake pan is thicker at the center than at the sides. This gives the cake a domed appearance when viewing from the side. Prior to baking the cake batter is poured into the pan. The batter then spreads out evenly over the floor of the pan. During baking, the batter along the sidewalls heats up faster than the batter in the middle. The batter at the sides expands upward and inward toward the center, pushing more uncooked batter toward the center. The batter in the center becomes thicker in this way and is additionally constrained such that when it expands it can only expand upward. The result is a cake that is thicker at the center than the edges. Often multiple cakes are stacked one on top of the other to form a layered cake. The domed top of a cake is often cut off and discarded to provide a flat top to facilitate stacking of the layers. However, removing the domed top also removes the harder outer layer, making it difficult to spread icing over the soft inner surface of the cake. It is also expensive and wasteful to discard the top of a cake in order to flatten it. It would therefore be beneficial to bake a cake that has a substantially flat surface when it is removed from the pan.

There exists prior art that attempted to solve the problem. U.S. Pat. No. 4,197,832 sets forth a solution where an insulating layer is wrapped around the outside wall of the cake pan. The insulating layer slows the transfer of heat from the vertical walls into the pan, causing he batter to heat evenly from the top and base surfaces. As well U.S. Pat. No. 5,012,947 set forth a solution where there exists a water chamber around the vertical walls of the cake pan. Like the insulator, the water keeps the vertical walls cooler than they would otherwise get during baking and the result is a cake that is more evenly cooked and flatter. The downside to the prior art is that it complicates the cake pans, increasing the cost of manufacturing and complexity of usage compared to a standard cake pan.

### SUMMARY OF THE INVENTION

One embodiment of the present invention provides a baking pan including a base having an interior surface including an interior center top surface and an interior peripheral bottom surface and a sidewall terminating at a top edge in a formed lip and transitioning at a bottom edge into the base. The sidewall has an interior sidewall span at the top edge. At least a portion of the base interior surface slopes upwardly from the interior peripheral bottom surface to the interior center top surface. The base interior surface does not slope downwardly from the interior peripheral bottom surface to interior center top surface. A vertical distance between the interior center top surface and the interior peripheral bottom surface does not exceed 10 percent of the interior sidewall span. The sidewall may be substantially vertical or slope outwardly from the sidewall bottom edge to the sidewall top edge. The vertical distance between the interior center top surface and the interior peripheral bottom surface may be between 5 and 15 millimeters. The interior center top surface may be substantially flat. The length of the interior center top surface is between 50 and 150 millimeters. The sloped sidewall may form an angle of 5 to 30 degrees.

Another embodiment of the present invention provides a baking pan including a base having an interior surface including an interior center top surface and an interior peripheral bottom surface and a sidewall terminating at a top edge in a formed lip and transitioning at a bottom edge into the base. The sidewall has an interior sidewall span at the top edge. The sidewall slopes outwardly from the sidewall bottom edge to the sidewall top edge. A vertical distance between the interior center top surface and the interior peripheral bottom surface does not exceed 10 percent of the interior sidewall span. The sidewall may form an angle of 5 to 30 degrees with vertical.

Another embodiment of the present invention provides an insert for a baking pan having a bottom wall and a sidewall terminating at a top edge in a formed lip and transitioning at a bottom edge into the bottom wall. The sidewall has an interior sidewall span at the top edge. The insert includes a base having an interior surface including an interior center top surface and an interior peripheral bottom surface. A vertical distance between the base interior center top surface and the base interior peripheral bottom surface does not exceed 10 percent of the interior sidewall span.

### BRIEF DESCRIPTION OF THE DRAWINGS

The invention will be better understood and objects other than those set forth will become apparent when consideration is given to the following detailed description thereof. Such description makes reference to the annexed drawings wherein:

FIG. 1 is a perspective view of the prior art;

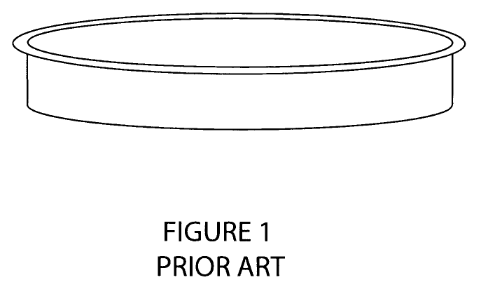

FIG. 2 is a perspective view of a second piece of prior art;

FIG. 3.is a section view of a baking pan according to one embodiment of the invention;

FIG. 4 is a section view of a baking pan having a combination flat and domed base according to another embodiment of the present invention;

FIG. 5 is section view of a baking pan having a tapered sidewall according to another embodiment of the present invention;

FIG. 6 is a section view of a baking pan having a conical base according to another embodiment of the present invention;

FIG. 7 is a section view of a baking pan having a spring form construction according to another embodiment of the present invention;

FIG. 8 is a section view of a standard cake pan with an insert according to one embodiment of the present;

FIG. 9 is a section view of a baking pan having a truncated domed base according to another embodiment of the present invention; and

FIG. 10 is a section view of a baking pan having a truncated domed base and a tapered sidewall according to another embodiment of the present invention.

### DETAILED DESCRIPTION

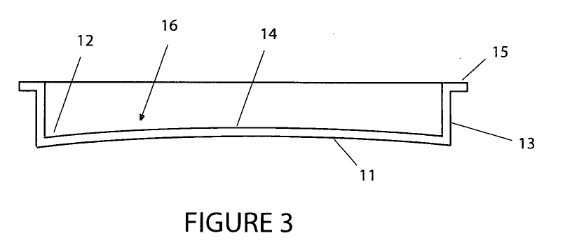

FIG. 3 illustrates a baking pan according to one embodiment of the present invention. The baking pan has a circular shape and generally includes a base 11 and a sidewall 13. The base 11 has an interior surface 16 including an interior center top surface 14 and an interior peripheral bottom surface 12. The sidewall 13 terminates at a top edge in a formed lip 15 and transitions at a bottom edge into the base 11. The sidewall 13 forms an uninterrupted cylinder. This sidewall 13 is vertical but may deviate from vertical to aid the removal of a baked cake or to make it easier to manufacture. The formed lip 15 is used to help carry the baking pan. The pan may be stamped out of a single-piece of metal material or molded out of any high temperature material suitable for baking.

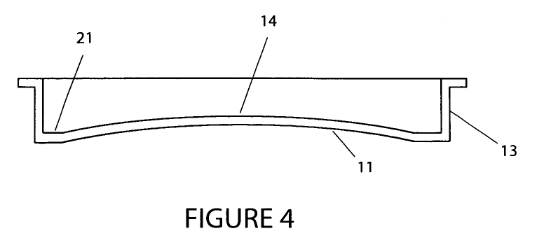

The dome shape of the base 11 is designed to compensate for the expansion of the cake batter during baking. With this expansion comes a tendency of the cake to rise first around the periphery and then bake inward toward the center. The base interior center top surface 14 is higher than the base interior peripheral bottom surface 12. The interior peripheral bottom surface 12 is circular in shape and occupies a plane that is parallel to whatever surface the baking pan is placed upon. The required vertical distance between the interior peripheral bottom surface 12 and the interior center top surface 14 depends on the total expansion of the cake batter. To achieve a substantially flat cake, the vertical distance between the interior center top surface and the interior peripheral bottom surface should not exceed 10 percent of the interior sidewall span at the sidewall top edge. For example, for a baking pan having an interior sidewall span or diameter of 230 millimeters, the vertical distance may be between 5 and 15 millimeters. The base 11 may continuously slope upwardly from the interior peripheral bottom surface 12 to the interior center top surface 14 as shown in FIG. 3. Or as shown in FIG. 4, the base 11 may have a flat peripheral surface 21 at the periphery. The flat peripheral surface 21 provides a smoother transition from the cylindrical wall and the base to avoid angles that are less than 90 degrees. A larger angle between the interior sidewall 13 and interior peripheral bottom surface 12 produces a cake that is easier to remove after baking.

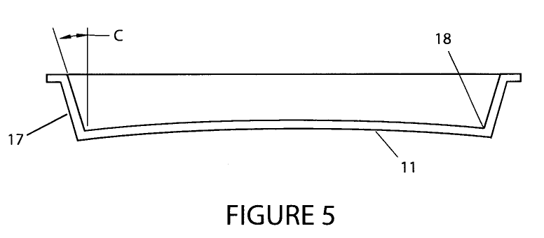

The sidewall 13 may be substantially vertical as shown in FIG. 3 or sloped outwardly forming a tapered sidewall 17 as shown in FIG. 5. The tapered wall 17 intersects with the interior peripheral bottom surface 18 of the base 11 and produces a substantially right angle between the tapered wall 17 and the domed base 11. The sidewall 17 may form an angle C of 5 to 30 degrees from vertical depending on the angle of the base 11. A baking pan that has a right angle between the interior peripheral bottom surface 18 and the interior sidewall 17 produces a cake with an angle between its base and sidewall that is nearly a right angle while still in the baking pan. After baking, when the cake is removed from the pan, the cake is flexible so the domed cake base flexes downward and lies flat on the horizontal surface upon which it is placed. The tapered sides of the cake are drawn inward, more so from the top of the cake sidewall than at the bottom of the cake sidewall. This results in a cake with a substantially flat top and substantially vertical walls when removed from the baking pan and placed upon a flat surface. FIG. 5 is shown with a continuously upwardly sloping base. However as in FIG. 4, the pan in FIG. 5 may include a flat section at the interior peripheral bottom surface 18. A flat section may further facilitate manufacture and removal of the cake after baking.

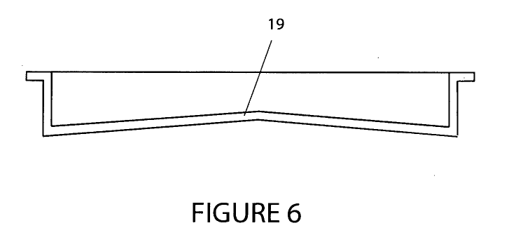

The base 11 may have a curved or domed profile as shown in FIG. 3 or an angled profile 19 as shown in FIG. 6. The profile in FIG. 6 results in a coned base 19 rather than the domed base 11. The coned base 19 of FIG. 6 may have a flat section at the periphery as in FIG. 4 or tapered sidewall 17 as FIG. 5. Like the domed base, for a baking pan having an interior sidewall span at the top edge of 230 millimeters, the vertical distance between the interior center top surface and the peripheral bottom surface is between 5 and 15 millimeters depending on the expansion of the particular cake recipe used.

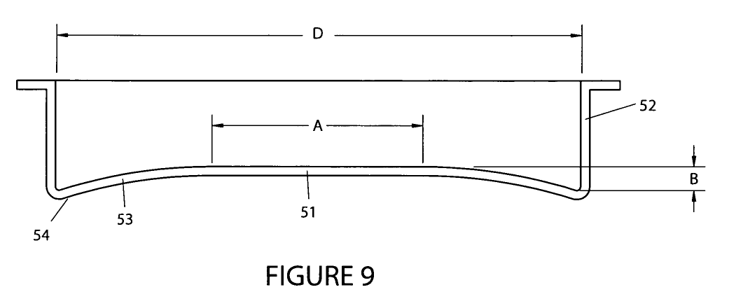

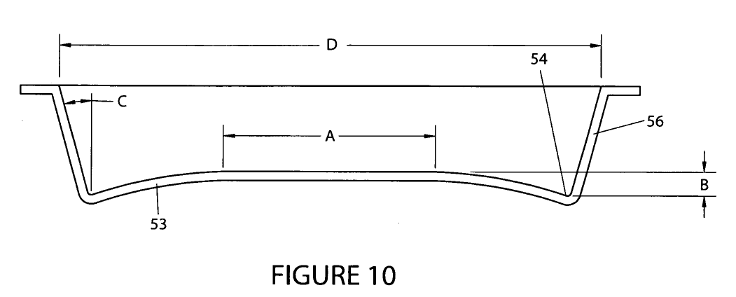

In another embodiment of the present invention, the baking pan may have a base 53 having an interior center top surface 51 that is flat at the center of the pan as shown in FIGS. 9 and 10. This is referred to as a truncated dome design. In FIG. 9, the baking pan sidewalls 52 are vertical or substantially vertical. The sidewall 52 transitions at the bottom edge into the base 53 having an interior peripheral surface 54 and the interior center top surface 51. The base 53 continuously slopes upwardly from the interior peripheral surface 54 to the interior center surface 51 at an angle to the horizontal that may be constant or variable. Within the interior center top surface 51 is a smaller flat section. The interior center top surface 51 may also be flat or nearly flat with a slight convex or concave dome. Each of these cases describes a baking pan that has a base with a dome proximate the periphery and substantially flat center section, thereby concentrating the effects of the domed base at the periphery of the cake and minimizing the effects of the domed base at the center of the cake. FIG. 9 shows a dimension A representing a length, in this embodiment a diameter, of the interior center top surface and a dimension B representing a vertical distance between the interior center top surface 51 and the interior peripheral bottom surface 54. For a baking pan with an interior sidewall span D of 230 millimeters, the diameter A may range between 50 and 150 millimeters and the vertical distance B may range between 5 and 15 millimeters. As the sidewall span of the baking pan increases, the diameter A will increase. If thicker flat cakes are required, the vertical distance B may also increase as needed.

FIG. 10 shows a similar pan to FIG. 9, except that the pan includes a sloped sidewall 56. The sidewall 56 may form an angle C of 5 to 30 degrees from vertical. After baking, the cake conforms to shape of the base 53 and the angled sidewalls 56 of the pan. In addition, while still in the cake pan of FIG. 10, the cake will have a domed top that nearly matches the shape of the pan base 53. Once the cake is removed from the pan the bottom of the cake that was resting on the truncated dome falls downward, and the top of the angled sidewalls are pulled inward creating a substantially vertical cake sidewall and a substantially flat cake top. A baking pan with such sloped sidewalls is easier to manufacture and several cake pans may be nested within each other to use less space when storing the pans. Though not shown, the base peripheral surface 54 may have a flat section like the pan shown in FIG. 4. This flat section may facilitate manufacture and removal of the cake after baking.

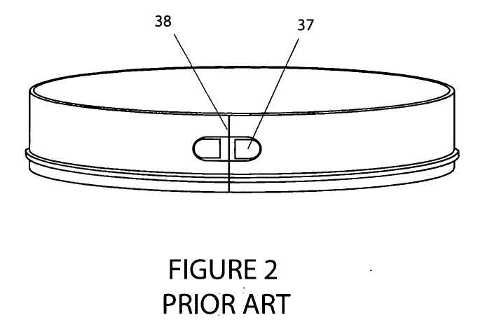

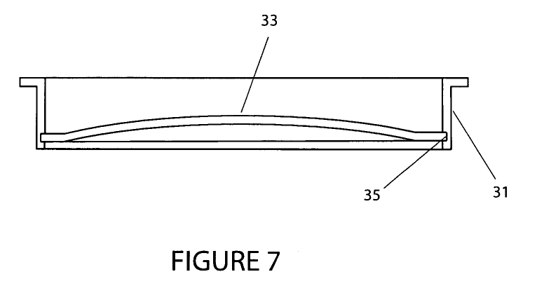

Another embodiment of the baking pan may follow a spring form construction and have a discrete sidewall 31 and a base 33 as shown in FIG. 7. In this embodiment, the sidewall 31 has a construction like the pan in FIG. 2. The sidewall 31 has a vertical split 38 so that it can open up to a larger diameter to accept the base 33. As seen in FIG. 7, the base 33 is a separate insert that keys into a feature 35 on the inside surface of the sidewall 31. The base 33 is then retained by the sidewall 31 as the sidewall 31 is locked as a closed cylinder with a clamp 37. In this embodiment, the wall section 31 may accept a base insert 33 that is similar in construction to any of the cake pan bases described in previous embodiments. Thus a spring form pan may be provided with a flat base for cakes that does not rise and a domed base for use with cakes that do rise during baking.

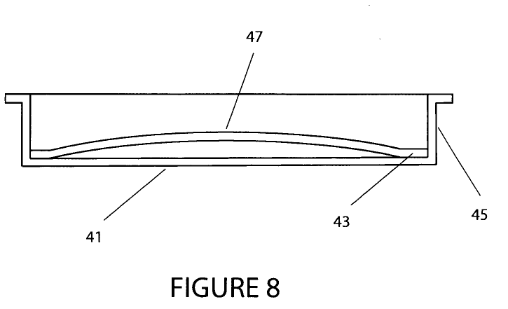

FIG. 8 shows another embodiment of a base insert 47 inserted in a standard cake pan that includes a base 47 as a separate removable insert. The standard cake pan includes a flat bottom wall 41 and vertical sidewalls 45. The base insert 47 is removeably located to lie on the top surface of the flat bottom wall 41. The base insert 47 may be made out of a stamped metal or a high temperature elastomer such as silicon. The peripheral edge 43 of the domed base 47 and the peripheral edge of the flat bottom wall 41 form a seal such that cake batter does not fill the space between the two as it is poured into the cake pan. The base insert 47 may be similar in construction to any of the baking pan bases described in previous embodiments. With this construction, the baking pan may be used with the additional domed base for cakes that rise during baking and with the flat base for cakes that do not.

While only selected embodiments have been chosen to illustrate the present invention, it will be apparent to those skilled in the art from this disclosure that various changes and modifications can be made herein without departing from the scope of the scope of the invention. Furthermore, the forgoing descriptions of the embodiments according to the present invention are provided for illustration only, and not for the purpose of limiting the invention. For example, the baking pans shown are circular in construction. The invention will provide the same benefits to baking pans that are not circular in shape. For example the invention could apply to a 13×9 inch rectangular pan. In this case instead of a conical base the pan will have a base shaped as a pyramid. And furthermore, instead of a truncated cone with a flat section in the center, a square or rectangular pan be constructed as a truncated pyramid with a center zone that is substantially higher than the at the outer zone and follows the overall shape of the pan base but smaller in size.

What is claimed:

1. A baking pan comprising:
a base having an interior surface including an interior center top surface and an interior peripheral bottom surface; and
a sidewall terminating at a top edge in a formed lip and transitioning at a bottom edge into the base, the sidewall having an interior sidewall span at the top edge,
wherein at least a portion of the base interior surface slopes upwardly from the interior peripheral bottom surface to the interior center top surface,
the base interior surface not sloping downwardly from the interior peripheral bottom surface to interior center top surface,
a vertical distance between the interior center top surface and the interior peripheral bottom surface not exceeding 10 percent of the interior sidewall span.

2. The baking pan of claim 1, wherein the sidewall is substantially vertical.

3. The baking pan of claim 2, wherein the vertical distance between the interior center top surface and the interior peripheral bottom surface is between 5 and 15 millimeters.

4. The baking pan of claim 3, wherein the interior center top surface is substantially flat.

5. The baking pan of claim 4, wherein a length of the interior center top surface is between 50 and 150 millimeters.

6. The baking pan of claim 1, wherein the sidewall slopes outwardly from the sidewall bottom edge to the sidewall top edge.

7. The baking pan of claim 6, wherein the vertical distance between the interior center top surface and the interior peripheral bottom surface is between 5 and 15 millimeters.

8. The baking pan of claim 7, wherein the interior center top surface is substantially flat.

9. The baking pan of claim 8, wherein a length of the interior center top surface is between 50 and 150 millimeters.

10. The baking pan of claim 6, wherein the sidewall forms an angle of 5 to 30 degrees from vertical.

11. The baking pan of claim 10, wherein the interior center top surface is substantially flat.

12. The baking pan of claim 11, wherein a length of the interior center top surface is between 50 and 150 millimeters.

13. An insert for a baking pan having a bottom wall and a sidewall terminating at a top edge in a formed lip and transitioning at a bottom edge into the bottom wall, the sidewall having an interior sidewall span at the top edge,
the insert comprising a base having an interior surface including an interior center top surface and an interior peripheral bottom surface,
a vertical distance between the base interior center top surface and the base interior peripheral bottom surface not exceeding 10 percent of the interior sidewall span.

14. The insert of claim 13, wherein the vertical distance between the interior center top surface and the interior peripheral bottom surface is between 5 and 15 millimeters.

15. The insert of claim 14, wherein the interior center top surface is substantially flat.

16. The insert of claim 15, wherein a length of the interior center top surface is between 50 and 150 millimeters.

17. A baking pan comprising:
a base having an interior surface including an interior center top surface and an interior peripheral bottom surface; and
a sidewall terminating at a top edge in a formed lip and transitioning at a bottom edge into the base, the sidewall having an interior sidewall span at the top edge,
the sidewall slopes outwardly from the sidewall bottom edge to the sidewall top edge,
a vertical distance between the interior center top surface and the interior peripheral bottom surface not exceeding 10 percent of the interior sidewall span.

18. The baking pan of claim 17, wherein the vertical distance between the interior center top surface and the interior peripheral bottom surface is between 5 and 15 millimeters.

19. The baking pan of claim 18, wherein the interior center top surface is substantially flat.

20. The baking pan of claim 19, wherein a length of the interior center top surface is between 50 and 150 millimeters.
